(19) United States
(12) Patent Application Publication
(10) Pub. No.: US 2025/0088244 A1
(43) Pub. Date: Mar. 13, 2025

(54) TRANSMITTING DATA TO FWA DEVICES

(71) Applicant: Telefonaktiebolaget LM Ericsson (publ), Stockholm (SE)

(72) Inventors: Niklas JALDÉN, Enköping (SE); Anders FURUSKÄR, Stockholm (SE)

(21) Appl. No.: 18/729,034

(22) PCT Filed: Feb. 7, 2022
(86) PCT No.: PCT/SE2022/050130

§ 371 Date: Jul. 15, 2024

(51) Int. Cl. H04B 7/06; H04L 5/00

(52) U.S. Cl. CPC H04B 7/0626; H04L 5/0044

(57) ABSTRACT

The present disclosure relates to a method of a radio base station of transmitting data to a wireless communication device, and a radio base station performing the method. In an aspect, a method of a radio base station of transmitting data to a wireless communication device is provided. The method includes identifying that the wireless communication device is a fixed wireless access (FWA) device, determining transmission parameters for the data to be transmitted to the wireless communication device based on acquired channel state information (CSI) for a channel to be established with the wireless communication device, transmitting the data to the wireless communication device by applying the acquired transmission parameters, and transmitting further data to the wireless communication device during subsequent communication sessions by reapplying the determined transmission parameters.

### TECHNICAL FIELD

The present disclosure relates to a method of a radio base station of transmitting data to a wireless communication device, and a radio base station performing the method.

### BACKGROUND

Fixed wireless access (FWA) technology is commonly used to offer wireless, or radio-based, connectivity to users in fixed positions. Radio connectivity may be supplied by a radio base station (RBS) to a customer premises equipment (CPE) in a fixed location, such as a wall- or roof-mounted stationary wireless access point, which in turn supplies radio connection to local moving users within coverage of the CPE. From the mobile network point of view, the end user is however stationary.

Another typical FWA setup constitutes a wireless router communicating with a radio base station, which router in its turn locally provides a group of devices such as mobile phones, computers, televisions sets, gaming consoles, etc. with a wireless connection to the RBS. Such router is semi-stationary in that it can be moved around the premises, but is usually placed in a fixed initial position and is thereafter not moved.

An FWA device (be it stationary or semi-stationary) is often used as an alternative to fibre installation in areas where fibre is not available or too costly.

Since the FWA device and RBS are stationary, or at least semi-stationary, dominating paths of the radio channel are fairly constant. To enable a higher number of simultaneous data streams, i.e. a higher-order multi-user (MU) multiple-input and multiple-output (MIMO), user devices connecting to the FWA device may be spatially multiplexed, wherein a high-rate signal is split into multiple lower-rate streams and each stream is transmitted from a different transmit antenna in the same frequency channel, thereby allowing the users to simultaneously receive data in contrast to single-user (SU) MIMO where only one device at a time is capable of receiving data.

To realize high order MU-MIMO, reciprocity-based precoding is typically used since estimating the channel based on uplink training sequences tends to provide richer channel state information (CSI) at the RBS, which is required for spatially multiplexing multiple data streams. However, the uplink training sequence requires transmission resources to be assigned and may further cause unnecessary interference. Further, determining precoders is typically more complex than using recommendations provided by of wireless communication devices as is commonly the case with codebooks.

### SUMMARY

One objective is to solve, or at least mitigate, this problem in the art and thus to provide an improved method of transmitting data to an FWA device.

This objective is attained in a first aspect by a method of a radio base station of transmitting data to a wireless communication device. The method comprises identifying that the wireless communication device is an FWA device, determining transmission parameters for the data to be transmitted to the wireless communication device based on acquired CSI for a channel to be established with the wireless communication device, transmitting the data to the wireless communication device by applying the acquired transmission parameters, and transmitting further data to the wireless communication device during subsequent communication sessions by reapplying the determined transmission parameters.

This objective is attained in a second aspect by a radio base station configured to transmit data to a wireless communication device, comprising a processing unit and a memory, said memory containing instructions executable by said processing unit, whereby the radio base station is operative to identify that the wireless communication device is an FWA device, determine transmission parameters for the data to be transmitted to the wireless communication device based on acquired CSI for a channel to be established with the wireless communication device, transmit the data to the wireless communication device by applying the acquired transmission parameters, and to transmit further data to the wireless communication device during subsequent communication sessions by reapplying the determined transmission parameters.

Thus, upon setting up a communication channel with an FWA device for performing a communication session, transmission parameters having been previously determined, such as having been computed from acquired CSI for the channel or estimated from historical CSI and/or transmission parameters shown to have a good result, are reapplied when transmitting data to the FWA device.

Advantageously, by reapplying determined transmission parameters over subsequent communication sessions with the FWA device, it is not necessary for the radio base station to acquire new CSI for each communication session being undertaken with the FWA device. Frequent transmission of training sequences from the FWA device to the radio base station, from which sequences the CSI is derived, may thus be avoided having as an effect that the amount of data transferred in the network—and any resulting interference and assigned amount of transmission resources—decreases.

In an embodiment, the method further comprises acquiring, after a predetermined time period has elapsed, new CSI for the channel to be established with the wireless communication device, determining if a difference between the acquired new CSI and the CSI on which currently applied transmission parameters is based exceeds a CSI accuracy threshold; and if so the determining of transmission parameters for the data to be transmitted to the wireless communication device comprises determining new transmission parameters for further data to be transmitted to the wireless communication device based on the acquired new CSI and applying the determined new transmission parameters when transmitting the further data. As is understood, in case of e.g. MU-MIMO, the transmission parameters of other devices being affected by the channel and corresponding CSI may also have to be (re-)determined.

Advantageously, after a time period has elapsed, the radio bases station checks that the CSI on which currently applied transmission parameters is based complies with a new acquired CSI. If not, new transmission parameters are determined based on the new CSI and applied for subsequent communication sessions.

In an embodiment, the acquiring of the new CSI for the channel to be established with the wireless communication device is only performed if network load is below a network load threshold. Advantageously, the network is not burdened with load resulting from the acquiring of new CSI in a scenario where the load already may be at a high level.

In an embodiment, the identifying that the wireless communication device is an FWA device comprises one of checking a device subscription indicating FWA status, determining User Equipment (UE) class of the wireless communication device, determining that the wireless communication device is equipped with directive antenna(s), identifying FWA status from an International Mobile Equipment Identity (IMEI) associated with the wireless communication device, acquiring a plurality of CSI sets for the wireless communication device indicating FWA status.

In an embodiment, in case at least one further FWA device is located in vicinity of the wireless communication device, a first set of transmission parameters is determined and applied for the data communicated to the wireless communication device if no data simultaneously is to be transmitted to the further FWA device while a second set of transmission parameters is determined and applied for the data communicated to the wireless communication device if data simultaneously is to be transmitted to the further FWA device, and a third set of transmission parameters is determined and applied for the data communicated to said further FWA device if no data simultaneously is to be transmitted to the wireless communication device, while a fourth set of transmission parameters is determined and applied for the data communicated to the further FWA device if data simultaneously is to be transmitted to the wireless communication device.

In an embodiment, the second set of transmission parameters is being configured such that the data transmitted to the wireless communication device does not cause interference at the further FWA device, and the fourth set of transmission parameters is being configured such that the data transmitted to the further FWA device does not cause interference at the wireless communication device.

In a third aspect, a computer program is provided comprising computer-executable instructions for causing a radio base station to perform steps recited in the method of the first aspect when the computer-executable instructions are executed on a processing unit included in the radio base station.

In a fourth aspect, a computer program product is provided comprising a computer readable medium, the computer readable medium having the computer program according to the third aspect embodied thereon.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a prior art wireless communication system utilizing FWA in which embodiments may be implemented;

FIG. 2 shows a flowchart illustrating a method of transmitting data to an FWA device according to an embodiment;

FIG. 3 shows a flowchart illustrating a method of transmitting data to an FWA device according to a further embodiment;

FIG. 4 shows a flowchart illustrating a method of transmitting data to an FWA device according to still a further embodiment;

FIG. 5 shows a flowchart illustrating a method of transmitting data to an FWA device according to still another embodiment

FIG. 6 illustrates a prior art wireless communication system comprising two FWA devices in vicinity of each other;

FIG. 7 illustrates transmission of data according to embodiments in four different scenarios; and

FIG. 8 illustrates a device configured to transmit data to an FWA device according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

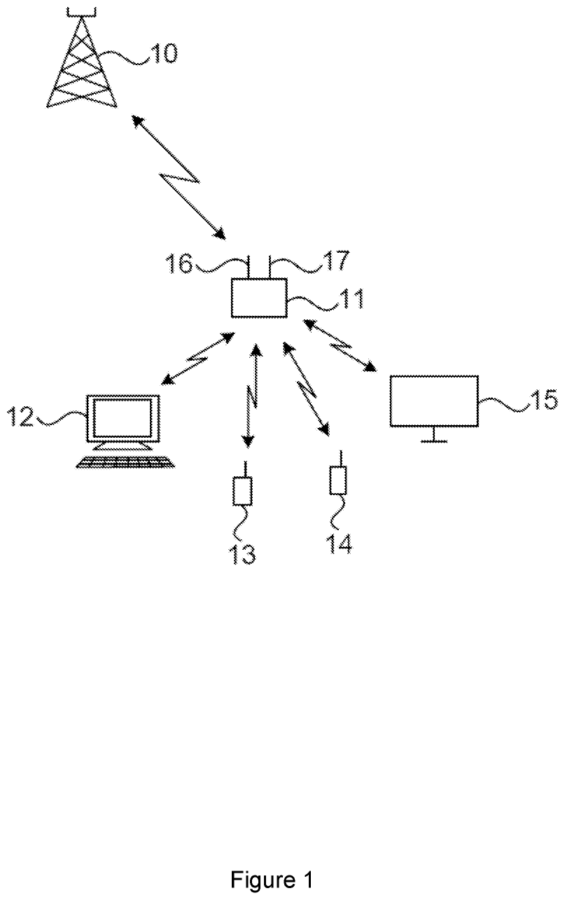

FIG. 1 illustrates an FWA setup where a radio base station (RBS) 10 communicates over a radio channel with an FWA device in the form of a wireless access point (WAP) 11 which in its turn provides a radio connection in the form of a local WiFi to a computer 12, a first mobile phone 13, a second mobile phone 14 and a television set 15 located within a coverage area of the WiFi provided by the WAP 11. These devices are commonly referred to as User Equipment (UE).

In this example, the wireless access point 11 is equipped with a first antenna 16 and a second antenna 17 thereby providing for a MIMO configuration in order to improve the quality of the radio channel established with the RBS 10.

As mentioned, in a MIMO configuration, spatial multiplexing may be implemented for increasing channel capacity. As further mentioned, channel capacity may be further increased by combining spatial multiplexing with precoding, which requires knowledge of channel state information (CSI).

Such CSI is acquired at the RBS 10 by having the WAP 11 send a training sequence from which the RBS 10 can evaluate the channel conditions for the WAP 11 and thus estimate the CSI.

However, the transmitting of uplink training sequences requires Sounding Reference Signal (SRS) resources to be assigned to the WAP 11 and any uplink training sequence transmission may further cause interference to other devices in the network.

Further, determining optimal precoders for the spatial multiplexing typically involves computations such as inverse operations of large matrices, which is not always feasible in real time. As a consequence, realistic schemes implies several simplifications in order to be realizable and such simplifications have a negative impact on precoder quality.

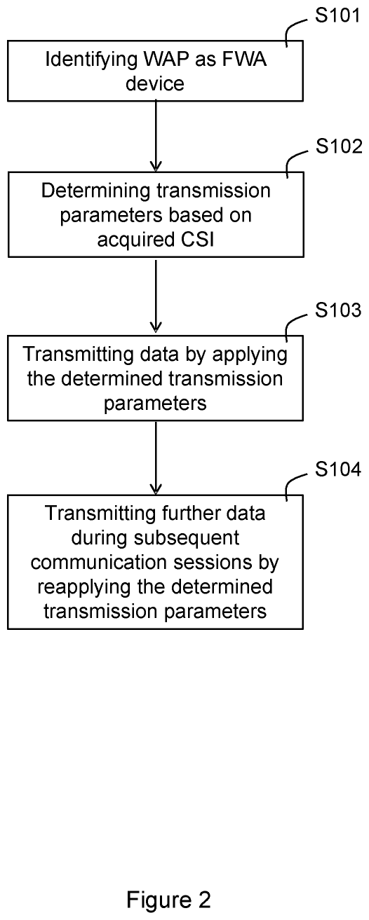

FIG. 2 illustrates a flowchart of a method for transmitting data to a wireless communication device being exemplified by an FWA device, i.e. the WAP 11.

In this exemplifying embodiment, it is assumed that during an initial setup of a communication channel with the WAP 11, the RBS 10 acquires CSI in step S101 as described hereinabove with reference to the art by having the WAP 11 transmit a training sequence from which the CSI is determined. Thereafter, transmission parameters are determined in step S102 for the data to be transmitted to the WAP 11 based on the acquired CSI, for instance by computing the transmission parameters or by mapping the acquired CSI to database entries comprising corresponding precomputed transmission parameters. These transmission parameters may serve as a basis for determining the previously discussed precoder applied when transmitting the data from the RBS 10 to the WAP 11.

The database may comprise user-specific transmission configurations, taking into account what has historically been good choices for transmission parameters for different CSIs, e.g. including suitable frequency bands, modulation and coding schemes, and MIMO configurations. Initially, rather than actually determining CSI based on a training sequence, transmission parameters that has previously proven to be good may be used, for instance in case network load currently is high. It may thus be envisaged that actually prevailing CSI subsequently is acquired when the network load has decreased, from which transmission parameters are determined. In an example, when initiating communication with a first FWA device, the transmission parameters of a neighbouring, already initiated FWA device is used for the first FWA device.

The data to be transmitted to the WAP 11 during the current communication session it thus transmitted in step S103 from the RBS 10 to the WAP 11 by applying these transmission parameters at the RBS 10, such as by determining an adequate precoder based on the transmission parameters.

Now, in this embodiment, upon the RBS 10 setting up subsequent communication sessions with the WAP 11 for transmitting further data as illustrated in step S104, the RBS 10 will reapply the transmission parameters already determined in step S102. The RBS 10 may acquire the transmission parameters for instance from a locally stored database in connection to the RBS 10 or a central network storage located e.g. in a core network to which the RBS 10 is connected.

A rationale for reusing the transmission parameters of previous communication sessions is that the WAP 11 is an FWA terminal and not a non-stationary device such as mobile phone, the position of which continuously changes.

The radio channel of the WAP 11 thus experiences little or no fading and may as a consequence be seen as constant over longer periods of time. In particular, distance-dependent attenuation does not vary, and shadow fading changes occur very rarely. In practice, properties of the radio channel of the WAP 11 will typically only change if the WAP 11 is substantially moved or if a structure such as a building is erected between the RBS 10 and the WAP 11, thereby changing the conditions of the channel and hence the CSI.

Advantageously, with this embodiment, it is not necessary for the RBS 10 to acquire new CSI for each communication session being undertaken with the WAP 11. Frequent transmission of training sequences from the WAP 11 to the RBS 10, from which sequences the CSI is derived, may thus be avoided having as an effect that the amount of data transferred in the network—and any resulting interference and assigned amount of transmission resources—decreases.

Further advantageous is that the determining of the transmission parameters based on the acquired CSI is undertaken less frequently which decreases computational burden of the RBS 10.

A communication session may be described as a period of information transfer. Consecutive sessions are separated in time by idle periods of no information transfer. Examples include periods of Internet surfing, viewing a number of webpages, performing a phone calls, etc, separated by idle periods. To save communication resources and energy, communication networks adapt to the communication sessions by setting up and terminating communication resources and contexts. This is undertaken in different parts of the networks, e.g. in the core network and the radio access network. Different states are used to reflect whether a user is in a session or not, such as active or idle states.

In an embodiment, new CSI is acquired after a given time period has elapsed from the instant in time when the previous CSI as acquired in order to ensure that the CSI for some reason has not changed. If the CSI has changed to a sufficiently high degree, it is preferable that the RBS 10 determines new transmission parameters based on the new, changed CSI for the WAP 11.

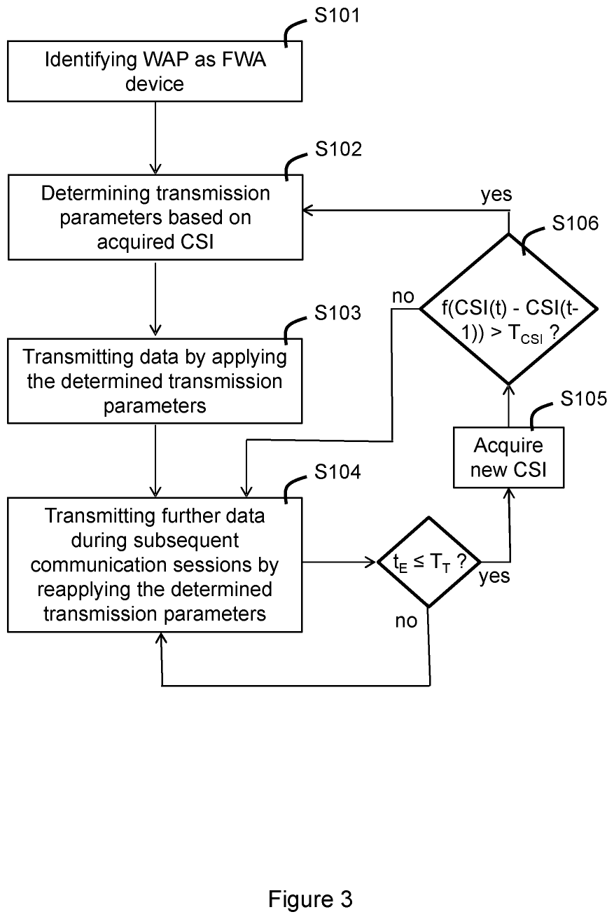

This embodiment is illustrated in the flowchart of FIG. 3, where after each performed communication session of step S104 it is determined whether or not a set time period the has elapsed, which time period may amount to minutes, hours, days, weeks or even months.

Unless the time period the has elapsed, the currently determined transmission parameters are applied for any subsequent data transmission communication session.

However, assuming that after a couple hours have elapsed—i.e. t_{E}>T_{T}, where T_{T}=2 hours—the RBS 10 acquires new CSI for the WAP 11 in step S105 based on training sequences transmitted by the WAP 11 and determines in step S106 if a difference between the new CSI(t) and the currently utilized CSI(t−1) exceeds a set CSI accuracy threshold T_{CSI}.

If not, the RBS 10 will continue to apply the already determined transmission parameters as illustrated in step S104 since the CSI on which the already determined transmission parameters is based still is valid.

If so, the CSI is considered to have changed to such an extent that new transmission parameters are to be determined based on the acquired new CSI as illustrated in step 102. Data is then transmitted to the WAP 11 from the RBS 10 based on the determined new transmission parameters for all communication sessions until time period T_{T} again has elapsed as shown in steps S103 and S104.

The difference is in step S106 illustrated as a subtraction, but other alternatives are envisaged, such as e.g. a ratio between the two, but other more complex relationships may be envisaged, where a function f(CSI(t), CSI(t−1)) is evaluated.

Advantageously, with this embodiment, the RBS 10 will occasionally reassess the CSI of the channel established with the WAP 11. For instance, it may be that the WAP 11 has been moved or even that some structure has been erected in or at the path of the radio channel.

In an embodiment, the time period is not necessarily static, but may be dynamically adapted. For instance, if after, say, T_{T}=10 minutes the CSI has not changed to any extent in step S106, T_{T} is adapted to T_{T}=1 hour. If after 1 hour no substantial change in CSI is detected, T_{T} is adapted to T_{T}=1 days, and so on. If a change in CSI indeed is detected in step S106, T_{T} may be reset to its initial value of T_{T}=1 hour.

In a further embodiment, the time period may be set to vary for different types or categories of WAPs. For instance, the time period may be set shorter for a wireless router than a wall-mounted CPE equipment, and even shorter for e.g. a smart phone being temporarily used as a local access point providing WiFi to other devices. Thus, depending on the type/category of FWA device, the time period for potentially collecting new CSI may vary. In another embodiment, the time period may be selected based on historical performance of an FWA device, where for an FWA device for which CSI has been more frequently updated, the time period is set to be shorter.

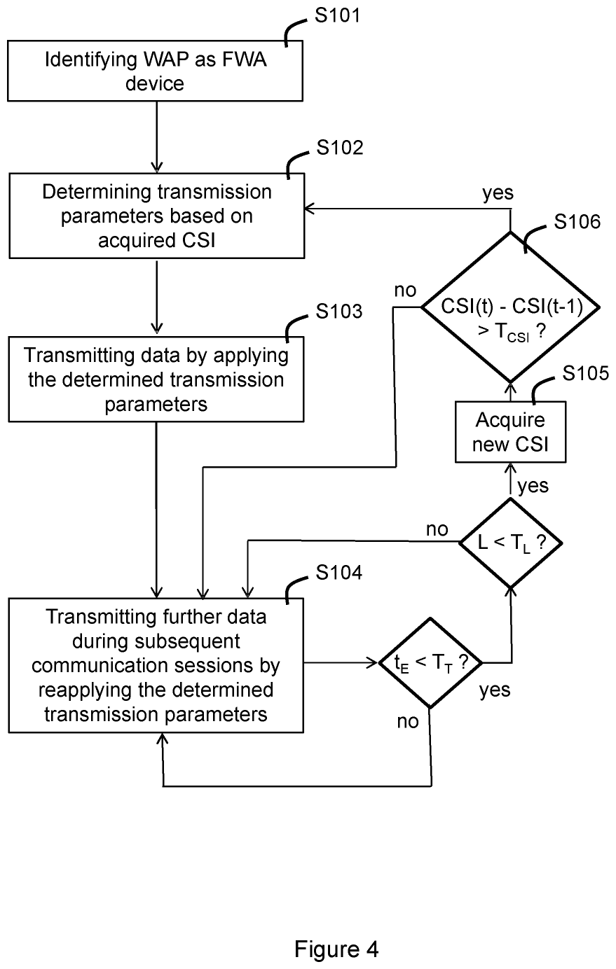

FIG. 4 illustrates a further embodiment wherein after the time period t_{E} has elapsed, i.e. t_{E}>T_{T}, and the RBS 10 concludes that new CSI is to be acquired in step S105, the RBS 10 will determine whether or not network load L currently is below a load threshold T_{L}.

If so, the RBS will continue with acquiring the new CSI as illustrated in step S105 and proceed as just described with reference to FIG. 3.

If not, the current network load is considered too high (i.e. L≥T_{L}) and the RBS 10 will continue to transmit data using the already determined transmission parameters as illustrated in step S104 until the network load L indeed is below the load threshold T_{L}.

Advantageously, acquiring CSI in low load scenarios limits additional interference in situations which already are interference limited and further improves utilization of limited resources.

Further, determining transmission parameters (and possibly downlink data precoders based on the transmission parameters) in between communication sessions relieves the RBS 10 from being burdened by computations during an ongoing session where the RBS 10 already is occupied with the transmission process for the WAP 11.

Moreover, determining transmission parameters in between communication sessions allows the determining to be performed offline by other nodes than the RBS 10, for instance a core network node such as a Mobility Management Entity (MME), a Serving Gateway (SW), a Packet Data Network Gateway (PGW), etc.

As discussed hereinabove with reference to step S101 of the various embodiment, the RBS 10 needs to identify the WAP 11 as an FWA device in order to conclude that any determined transmission parameters can reapplied over subsequent communication sessions with the WAP 11.

For instance, the WAP 11 may (a) hold a subscription indicating FWA status, (b) be equipped with directive antenna(s) as compared to a non-stationary device such as a mobile phone or a tablet thereby indirectly identifying the device as an FWA device, or (c) be identified from an International Mobile Equipment Identity (IMEI) associated with the FWA device, indicating for instance that the WAP 11 is a router or be identified from UE class.

In another example, the RBS 10 may acquire a plurality of CSI sets from the WAP 11 and make the assessment from the CSI sets that the channel established with the WAP 11 is/has been constant over longer periods of time, thereby indicating that the WAP 11 is a non-mobile device (or at least being temporarily stationary, such as a smart phone being used as an access point or a 5G-capable laptop).

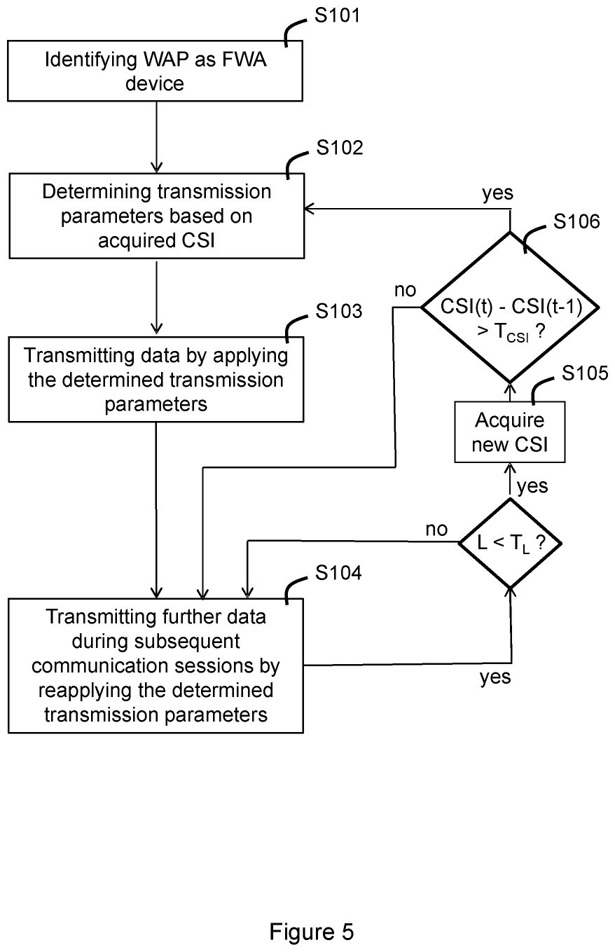

Further, FIG. 5 illustrates an embodiment where after a communication session has been undertaken, the RBS 10 checks whether the network load L is below the load threshold T_{L} and if so a new CSI is acquired. Thus, in the embodiment of FIG. 5, the RBS 10 does not wait until the time period the has elapsed but utilizes low-load situations in between communication sessions to acquire new CSI.

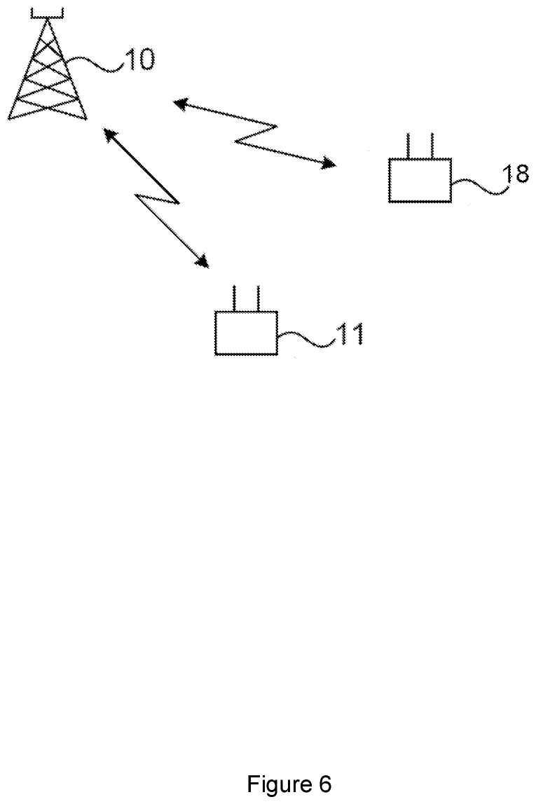

FIG. 6 illustrates a further embodiment where a further FWA device 18 is to be served by the RBS 10, which is located in vicinity of the WAP 11. For instance, the further FWA device 18 may be a CPE device located at a neighbouring house.

In such a scenario, the RBS 10 may take advantage of co-scheduling transmission of data the WAP 11 and the CPE device 18, thereby allowing doubling the capacity since the data may be sent to two devices simultaneously. In this exemplifying embodiment, two FWA devices 11, 18 are illustrated, but any appropriate number of devices to be co-scheduled is envisaged.

As is understood, the RBS 10 will determine appropriate transmission parameters to be applied when transmitting data to the CPE device 18 based on acquired CSI for the channel established between the RBS 10 and the CPE device 18 as already has been described in detail for the WAP 11 with reference to FIGS. 2-4.

Further similar to the transmission parameters determined for the WAP 11, the determined transmission may not change for months or even years due to the stationary nature of the WAP 11. In the case of the CPE device 18, which typically is fixedly wall- or roof-mounted, the CSI and resulting transmission parameter are even less likely to change.

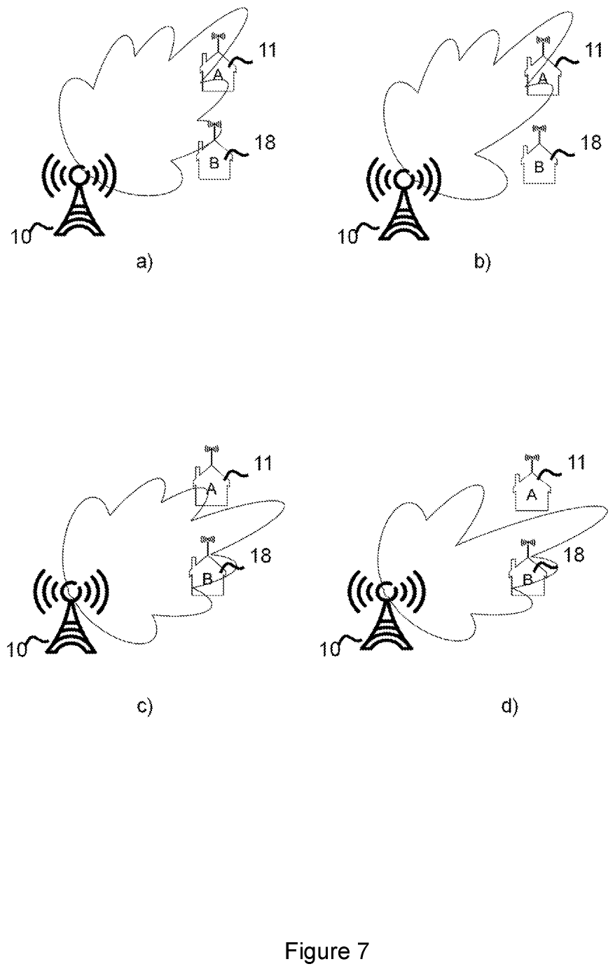

FIG. 7 illustrates four scenarios a-d where different transmission parameters (and thus resulting precoders) will be selected when performing the transmission of data from the RBS 10.

Three transmission cases are possible:
1) transmission of data is performed only to the WAP 11,
2) transmission of data is performed only to the CPE device 18, and
3) transmission of data is performed simultaneously to both the WAP 11 and the CPE device 18 (i.e. co-scheduling is undertaken by the RBS 10)

In transmission case 1), a first set of transmission parameters resulting in scenario a) is selected (it is assumed that these already have been determined and can fetched by the RBS 10 e.g. from a local storage). As illustrated in scenario a) of FIG. 7, the selected first set of transmission parameters for transmitting data to the WAP 11 may cause some interference to the CPE device 18. However, since there is no current scheduling of data to be transmitted to the CPE device 18, this interference is not a problem.

For transmission case 1), the RBS 10 could alternatively have selected a second set of transmission parameters resulting in scenario b), in which case the transmission of data to the WAP 11 would not cause any interference to the CPE device 18. However, higher-power signals would typically be transmitted to the WAP 11 using the transmissions parameters of scenario a) as compared to b). Therefore, it is advantageous to select the first set of transmission parameters resulting in scenario a) rather than the second set of transmission parameters resulting in scenario b).

In transmission case 2), a third set of transmission parameters resulting in scenario c) is selected. As illustrated in scenario c) of FIG. 7, the selected third set of transmission parameters for transmitting data to the CPE device 18 may cause some interference to the WAP 11. However, since there is no current scheduling of data to be transmitted to the WAP 11, this interference is not a problem.

Similar to transmission case 1), the RBS 10 could in transmission case 2) alternatively have selected a fourth set of the transmission parameters resulting in scenario d), in which case the transmission of data to the CPE device 18 would not cause any interference to the WAP 11 but since higher-power signals typically would be transmitted to the WAP 11 using the transmissions parameters of scenario c) as compared to d), it is advantageous to select the third set of transmission parameters resulting in scenario c) rather than the fourth set of transmission parameters resulting in scenario d).

In transmission case 3), the second set of transmission parameters resulting in scenario b) is selected for the data transmitted to the WAP 11, while the fourth set of transmission parameters resulting in scenario d) is selected for the data transmitted to the CPE device 18.

As is understood, in transmission case 3) it would not be advisable to select the first set of transmission parameters resulting in scenario a) for the data transmitted to the WAP 11, since such transmission parameters would result in interference at the CPE device 18. Similarly, it would not be advisable to select the third set of transmission parameters resulting in scenario c) for the data transmitted to the CPE device 18, since such transmission parameters would result in interference at the WAP 11.

As previously mentioned, in case new transmission parameters are determined for the WAP 11 based on new CSI, new CSI may have to be acquired for the CPE device 18 as well and new transmission parameters being determined for the CPE device 18, since properties of the channel established with the WAP 11 may affect properties of the channel established with the CPE device 18.

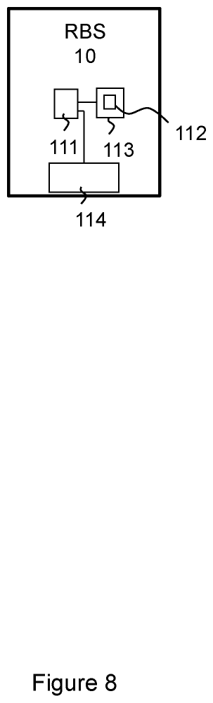

FIG. 8 illustrates a device 10, such as an RBS, configured to transmit data to an FWA device according to an embodiment, where the steps of the method performed by the device 10 in practice are performed by a processing unit 111 embodied in the form of one or more microprocessors arranged to execute a computer program 112 downloaded to a storage medium 113 associated with the microprocessor, such as a Random Access Memory (RAM), a Flash memory or a hard disk drive. The processing unit 111 is arranged to cause the device 10 to carry out the method according to embodiments when the appropriate computer program 112 comprising computer-executable instructions is downloaded to the storage medium 113 and executed by the processing unit 111. The storage medium 113 may also be a computer program product comprising the computer program 112. Alternatively, the computer program 112 may be transferred to the storage medium 113 by means of a suitable computer program product, such as a Digital Versatile Disc (DVD) or a memory stick. As a further alternative, the computer program 112 may be downloaded to the storage medium 113 over a network. The processing unit 111 may alternatively be embodied in the form of a digital signal processor (DSP), an application specific integrated circuit (ASIC), a field-programmable gate array (FPGA), a complex programmable logic device (CPLD), etc. The device 10 further comprises a communication interface 114 (wired and/or wireless) over which the device 10 is configured to transmit and receive data.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of a radio base station of transmitting data to a wireless communication device, comprising:
identifying that the wireless communication device is a fixed wireless access, FWA, device;
determining transmission parameters for the data to be transmitted to the wireless communication device based on acquired channel state information, CSI, for a channel to be established with the wireless communication device;
transmitting the data to the wireless communication device by applying the acquired transmission parameters; and
transmitting further data to the wireless communication device during subsequent communication sessions by reapplying the determined transmission parameters.

2. The method of claim 1, further comprising:
acquiring, after a time period has elapsed, new CSI for the channel to be established with the wireless communication device;
determining if a difference between the acquired new CSI and the CSI on which currently applied transmission parameters is based exceeds a CSI accuracy threshold; and if so the determining of transmission parameters for the data to be transmitted to the wireless communication device comprises:
determining new transmission parameters for further data to be transmitted to the wireless communication device based on the acquired new CSI and applying the determined new transmission parameters when transmitting the further data.

3. The method of claim 2, wherein the time period is set based on historical performance of the wireless communication device or to which category of device the wireless communication device belongs, or to set the time period such that it is extended each time the determined difference between the acquired new CSI and the CSI on which currently applied transmission parameters is based does not exceed a CSI accuracy threshold.

4. The method of claim 1, wherein the acquiring of the new CSI for the channel to be established with the wireless communication device only is performed if network load is below a network load threshold.

5. The method of claim 1, wherein the identifying that the wireless communication device is an FWA device comprises one of: checking a device subscription indicating FWA status, determining User Equipment, UE, class of the wireless communication device, determining that the wireless communication device is equipped with directive antenna(s), identifying FWA status from an International Mobile Equipment Identity, IMEI associated with the wireless communication device, acquiring a plurality of CSI sets for the wireless communication device indicating FWA status.

6. The method of claim 1, wherein in case at least one further FWA device is located in vicinity of the wireless communication device, a first set of transmission parameters is determined and applied for the data communicated to the wireless communication device if no data simultaneously is to be transmitted to the further FWA device while a second set of transmission parameters is determined and applied for the data communicated to the wireless communication device if data simultaneously is to be transmitted to the further FWA device, and a third set of transmission parameters is determined and applied for the data communicated to said further FWA device if no data simultaneously is to be transmitted to the wireless communication device, while a fourth set of transmission parameters is determined and applied for the data communicated to the further FWA device if data simultaneously is to be transmitted to the wireless communication device.

7. The method of claim 6, the second set of transmission parameters being configured such that the data transmitted to the wireless communication device does not cause interference at the further FWA device, and the fourth set of transmission parameters being configured such that the data transmitted to the further FWA device does not cause interference at the wireless communication device.

8. (canceled)

9. A computer program product comprising a non-transitory computer readable medium including program code to be executed by at least one processor of a radio base station, whereby execution of the program code causes the program code to perform operation comprising:
identify that the wireless communication device is a fixed wireless access, FWA, device;
determine transmission parameters for the data to be transmitted to the wireless communication device based on acquired channel state information, CSI, for a channel to be established with the wireless communication device;
transmit the data to the wireless communication device by applying the acquired transmission parameters; and
transmit further data to the wireless communication device during subsequent communication sessions by reapplying the determined transmission parameters.

10. A radio base station configured to transmit data to a wireless communication device, comprising at least one processor and a memory, said memory containing instructions executable by the at least one processor, whereby the radio base station is operative to:
identify that the wireless communication device is a fixed wireless access, FWA, device;
determine transmission parameters for the data to be transmitted to the wireless communication device based on acquired channel state information, CSI, for a channel to be established with the wireless communication device;
transmit the data to the wireless communication device by applying the acquired transmission parameters; and
transmit further data to the wireless communication device during subsequent communication sessions by reapplying the determined transmission parameters.

11. The radio base station of claim 10, further being operative to:
acquire, after a time period has elapsed, new CSI for the channel to be established with the wireless communication device;
determine if a difference between the acquired new CSI and the CSI on which currently applied transmission parameters is based exceeds a CSI accuracy threshold; and if so being operative to, when determining transmission parameters for the data to be transmitted to the wireless communication device:
determine new transmission parameters for further data to be transmitted to the wireless communication device based on the acquired new CSI and applying the determined new transmission parameters when transmitting the further data.

12. The radio base station of claim 11, further being operative to set the time period based on historical performance of the wireless communication device or to which category of device the wireless communication device belongs, or to set the time period such that it is extended each time the determined difference between the acquired new CSI and the CSI on which currently applied transmission parameters is based does not exceed a CSI accuracy threshold.

13. The radio base station of claim 10, wherein the acquiring of the new CSI for the channel to be established with the wireless communication device only is performed if network load is below a network load threshold.

14. The radio base station of claim 10, being operative to, when identifying that the wireless communication device is an FWA device: checking a device subscription indicating FWA status, determining User Equipment, UE, class of the wireless communication device, determining that the wireless communication device is equipped with directive antenna(s), identifying FWA status from an International Mobile Equipment Identity, IMEI associated with the wireless communication device, acquiring a plurality of CSI sets for the wireless communication device indicating FWA status.

15. The radio base station of claim 10, wherein in case at least one further FWA device is located in vicinity of the wireless communication device, radio base station is operative to determine and apply a first set of transmission parameters for the data communicated to the wireless communication device if no data simultaneously is to be transmitted to the further FWA device while a second set of transmission parameters is determined and applied for the data communicated to the wireless communication device if data simultaneously is to be transmitted to the further FWA device, and a third set of transmission parameters is determined and applied for the data communicated to said further FWA device if no data simultaneously is to be transmitted to the wireless communication device, while a fourth set of transmission parameters is determined and applied for the data communicated to the further FWA device if data simultaneously is to be transmitted to the wireless communication device.

16. The radio base station of claim 15, the second set of transmission parameters being configured such that the data transmitted to the wireless communication device does not cause interference at the further FWA device, and the fourth set of transmission parameters being configured such that the data transmitted to the further FWA device does not cause interference at the wireless communication device.

17. The computer program product of claim 9, said memory containing instructions executable by the at least one processor, whereby the radio base station is operative to perform further operations further comprising:
acquire, after a time period has elapsed, new CSI for the channel to be established with the wireless communication device;
determine if a difference between the acquired new CSI and the CSI on which currently applied transmission parameters is based exceeds a CSI accuracy threshold; and if so the determine of transmission parameters for the data to be transmitted to the wireless communication device comprises:
determine new transmission parameters for further data to be transmitted to the wireless communication device based on the acquired new CSI and applying the determined new transmission parameters when transmitting the further data.

18. The computer program product of claim 19, wherein the time period is set based on historical performance of the wireless communication device or to which category of device the wireless communication device belongs, or to set the time period such that it is extended each time the determined difference between the acquired new CSI and the CSI on which currently applied transmission parameters is based does not exceed a CSI accuracy threshold.

19. The computer program product of claim 9, wherein the acquire of the new CSI for the channel to be established with the wireless communication device only is performed if network load is below a network load threshold.

20. The computer program product of claim 9, wherein the identify that the wireless communication device is an FWA device comprises one of: checking a device subscription indicating FWA status, determining User Equipment, UE, class of the wireless communication device, determine that the wireless communication device is equipped with directive antenna(s), identify FWA status from an International Mobile Equipment Identity, IMEI associated with the wireless communication device, acquire a plurality of CSI sets for the wireless communication device indicating FWA status.

21. The computer program product of claim 9, wherein in case at least one further FWA device is located in vicinity of the wireless communication device, a first set of transmission parameters is determined and applied for the data communicated to the wireless communication device if no data simultaneously is to be transmitted to the further FWA device while a second set of transmission parameters is determined and applied for the data communicated to the wireless communication device if data simultaneously is to be transmitted to the further FWA device, and a third set of transmission parameters is determined and applied for the data communicated to said further FWA device if no data simultaneously is to be transmitted to the wireless communication device, while a fourth set of transmission parameters is determined and applied for the data communicated to the further FWA device if data simultaneously is to be transmitted to the wireless communication device.
